(19) United States
(12) Patent Application Publication
(10) Pub. No.: US 2023/0180787 A1
(43) Pub. Date: Jun. 15, 2023

(54) FROZEN DESSERTS AND METHODS THEREOF

(71) Applicant: WELLS ENTERPRISES, INC., Le Mars, IA (US)

(72) Inventors: Dipak MEHTA, Le Mars, IA (US); Jon OLDROYD, Le Mars, IA (US)

(21) Appl. No.: 17/546,260

(22) Filed: Dec. 9, 2021

(51) Int. Cl. A23G 9/48; A23G 9/50; A23G 9/42; A23G 9/40

(52) U.S. Cl. CPC A23G 9/48; A23G 9/40; A23G 9/42; A23G 9/503; A23G 1/305; A23G 2220/12; A23G 2220/20

(57) ABSTRACT

The present disclosure provides cold dessert comprising a frozen edible composition and an oil combined with the frozen composition, wherein the cold dessert has an outer surface. Various methods of making the cold dessert are also provided.

### BACKGROUND AND SUMMARY

Continued interest in a ketogenic diet has recently shifted consumer demand to food categories that are high in fat and low in carbohydrates. In 2018, the word “keto” was the most common search term on Google in food-related categories. Based on a recent market studies, the ketogenic food market is projected to grow at a compound annual growth rate of 5.3% through 2026 the expected market growth of foods for the keto diet could grow from $9.6 billion in 2018 to $15.6 billion by 2027.

However, currently available keto-friendly foods in the frozen confection area are either uncoated or are coated with a compound chocolate in a combination with inclusions such as nuts pieces. This feature leads to product appearance related concerns that are undesired by consumers because of an inferior surface quality. Even though the addition of inclusions in a compound chocolate can provide less-noticeable surface imperfections, current product offerings still suffer from the same problems.

As such, there is a need for new keto-friendly frozen confections with improved surface qualities in order to avoid concerns with product appearance. The cold desserts according to the present disclosure provide a solution to satisfy the growing need of consumers.

In an illustrative aspect, a cold dessert is provided. The cold dessert comprises i) a frozen edible composition and ii) an oil combined with the frozen composition, wherein the cold dessert has an outer surface.

In an illustrative aspect, a method of making a cold dessert having an outer surface is provided. The method comprises the step of combining a frozen edible composition with an oil to form the cold dessert.

In an illustrative aspect, a second method of making a cold dessert having an outer surface is provide. The method comprises the step of combining a frozen edible composition with an oil to form the cold dessert, wherein the oil present in an oil container and wherein the oil is added to the frozen edible composition via a pump from the oil container.

### BRIEF DESCRIPTION OF THE DRAWINGS

FIG. 1 shows a composition comprising a frozen edible composition but does not comprise an oil, with a fat-based coating added to its outer surface. This cold dessert demonstrates an inferior surface quality.

FIG. 2 shows a composition comprising a frozen edible composition and an oil, with a fat-based coating added to its outer surface. This cold dessert demonstrates an improved surface quality as indicated by its smooth exterior.

FIG. 3 shows microscopic images of fat agglomeration of two tested samples (40X). Sample A is shown at the top and Sample B is shown at the bottom.

FIG. 4 shows microscopic images of fat agglomeration of two tested samples (100X). Sample A is shown at the top and Sample B is shown at the bottom.

FIG. 5 shows microscopic images of fat agglomeration of two tested samples (400X). Sample A is shown at the top and Sample B is shown at the bottom.

FIG. 6 shows microscopic images of fat agglomeration of two tested samples (400X), with a focus on air cells present in the samples. Sample A is shown on the left and Sample B is shown on the right.

### DETAILED DESCRIPTION

For the purposes of promoting an understanding of the principles of the disclosure, reference will now be made to a number of illustrative embodiments and specific language will be used to describe the same.

In an illustrative aspect, a cold dessert is provided. The cold dessert comprises i) a frozen edible composition and ii) an oil combined with the frozen composition, wherein the cold dessert has an outer surface. For instance, the oil can be mixed with the frozen composition or the blended with the frozen composition.

As used herein, “cold” refers to temperatures between about -75° C. and about 10° C. In some embodiments, the cold desserts of the present disclosure have a temperature between about -75° C. and about 0° C., about -75° C. and about 3° C., -40° C. and about 5° C., about -30° C. and about 5° C., about -25° C. and about 3° C., and/or about -20° C. and about 0° C.

Cold desserts according to the present disclosure include but are not limited to cold dairy-based desserts, cold diary-substitute-based desserts, cold plant-based desserts, ice cream, soft-serve ice cream, gelato, frozen custard, soy milk ice cream, nut milk ice cream, coconut milk ice cream, avocado-based ice cream, frozen yogurt, frozen Greek yogurt, frozen kefir, a parfait, sorbet, sherbet, a frozen novelty, a fruit frozen novelty, a fudge frozen novelty, a frozen stick confection, a fruit frozen stick confection, a fudge frozen stick confection, a water ice confection, a fruit water ice confection, a fudge water ice confection, cheesecake, cake, pie, a milkshake, a malt, a smoothie, frozen fruit, Italian ice, a snow cone, whipped cream, and combinations of the foregoing.

The term “frozen,” as used herein, denotes that the product is solidified under freezing conditions to a hardpack or pumpable consistency which not fluid or semi-fluid. By “base” or “base frozen confection”, it is meant that the frozen confection excluding the ingredients which will exists non-homogenously in the confection, e.g., inclusions and variegates such as visibly identifiable viscous flavorings like fudge and caramel swirls, nut pieces, cookie dough pieces, baked pieces, candies, etc.

In an embodiment, the frozen edible composition comprises a base composition. In an embodiment, the base composition comprises an ingredient selected from the group consisting of milk, ultrafiltered milk, low-lactose milk, whole milk, buttermilk, skim milk, ultrafiltered low-lactose skim milk, cream, water, cocoa powder, sweetener, inulin, soluble corn fiber, sugar alcohol, stabilizer, emulsifier, and any combination thereof.

In an embodiment, the frozen edible composition comprises an ingredient selected from the group consisting of salt, sea salt, natural flavors, inclusions, variegates, and any combination thereof.

In an embodiment, the frozen edible composition comprises an ingredient selected from the group consisting of fruits, nuts, chocolate-based inclusions, chocolate-based variegates, and any combination thereof.

In an embodiment, the frozen edible composition comprises an ingredient selected from the group consisting of vanilla, nut extract, peanut extract, chocolate flavor, chocolate cheesecake flavor, caramel variegate, sea salt caramel variegate, strawberry variegate, blueberry variegate, peanut variegate, peanut butter variegate, peanut butter flake variegate, chocolate variegate, chocolate fudge variegate, fudge variegate, and any combination thereof.

The cold dessert may be aerated and have overrun between 15-125%, preferably between 60-110%. Overrun is defined by the equation below and is measured at atmospheric pressure.

$$\begin{matrix}\text{Overrun} \left(\text{\%}\right) \text{=} \\ \left[\left(\text{Density} \text{of} \text{mix-Density} \text{of} \text{cold} \text{dessert}\right) / \text{Density} \text{of} \text{} \text{cold} \text{dessert}\right] \times 100\end{matrix}$$

In an embodiment, the cold dessert comprises a fat-based coating configured to interface with the outer surface of the cold dessert. For instance, the fat-based coating can be applied to the outer surface of the cold dessert via a coating mechanism such as dipping or spraying.

In an embodiment, the fat-based coating comprises a chocolate. In an embodiment, the fat-based coating comprises a confection.

In an embodiment, the oil comprises a low-melt oil. In an embodiment, the low-melt oil is an edible low-melt oil. In an embodiment, the low-melt oil is selected from the group consisting of peanut oil, soybean oil, canola oil, sunflower oil, safflower oil and any combination thereof.

In an embodiment, the cold dessert comprises a continuous phase, and wherein the continuous phase comprises fat agglomeration. Generally, fat agglomeration is a common phenomenon that occurs during the production of a cold dessert that comprises a fat and an emulsifier.

In an embodiment, the fat agglomeration of the cold dessert is larger than fat agglomeration of a comparative cold dessert, wherein the comparative cold dessert does not comprise an oil. As demonstrated in the examples of the present disclosure, the presence of an oil in cold desserts was discovered to result in a larger amount of fat agglomeration compared to the scenario when cold desserts do not comprise an oil. Thus, the inclusion of the oil in the cold dessert provides an improved surface quality as indicated by the observed smooth exterior. These results were unexpected.

In an embodiment, the cold dessert comprises a lower number of voids on the outer surface of the cold dessert in comparison to a comparative cold dessert comprising voids, wherein the comparative cold dessert does not comprise an oil. Again, the inclusion of the oil in the cold dessert provides this unexpected result.

In an embodiment, the cold dessert comprises a lower number of air pockets on the outer surface of the cold dessert in comparison to a comparative cold dessert comprising air pockets, wherein the comparative cold dessert does not comprise an oil. Again, the inclusion of the oil in the cold dessert provides this unexpected result.

In an illustrative aspect, a method of making a cold dessert having an outer surface is provided. The method comprises the step of combining a frozen edible composition with an oil to form the cold dessert.

In an embodiment, the combining of the frozen edible composition and the oil provides fat agglomeration in a continuous phase of the cold dessert. In an embodiment, the fat agglomeration of the cold dessert is larger than fat agglomeration of a comparative cold dessert, wherein the comparative cold dessert does not comprise an oil.

In an embodiment, the combining of the frozen edible composition and the oil provides a lower number of voids on the outer surface of the cold dessert in comparison to a comparative cold dessert comprising voids, wherein the comparative cold dessert does not comprise an oil.

In an embodiment, the combining of the frozen edible composition and the oil provides a lower number of air pockets on the outer surface of the cold dessert in comparison to a comparative cold dessert comprising air pockets, wherein the comparative cold dessert does not comprise an oil.

In an embodiment, the method further comprises a step of contacting the cold dessert with a fat-based coating, wherein the fat-based coating is applied to the outer surface of the cold dessert. In an embodiment, the fat-based coating comprises a chocolate. In an embodiment, the fat-based coating comprises a confection.

In an embodiment, the frozen edible composition comprises a base composition. In an embodiment, the base composition comprises an ingredient selected from the group consisting of milk, ultrafiltered milk, low-lactose milk, whole milk, buttermilk, skim milk, ultrafiltered low-lactose skim milk, cream, water, cocoa powder, sweetener, inulin, soluble corn fiber, sugar alcohol, stabilizer, emulsifier, and any combination thereof.

In an embodiment, the frozen edible composition comprises an ingredient selected from the group consisting of salt, sea salt, natural flavors, inclusions, variegates, and any combination thereof.

In an embodiment, the frozen edible composition comprises an ingredient selected from the group consisting of fruits, nuts, chocolate-based inclusions, chocolate-based variegates, and any combination thereof.

In an embodiment, the frozen edible composition comprises an ingredient selected from the group consisting of vanilla, nut extract, peanut extract, chocolate flavor, chocolate cheesecake flavor, caramel variegate, sea salt caramel variegate, strawberry variegate, blueberry variegate, peanut variegate, peanut butter variegate, peanut butter flake variegate, chocolate variegate, chocolate fudge variegate, fudge variegate, and any combination thereof.

In an embodiment, the oil comprises a low-melt oil. In an embodiment, the low-melt oil is an edible low-melt oil. In an embodiment, the low-melt oil is selected from the group consisting of peanut oil, soybean oil, canola oil, sunflower oil, safflower oil and any combination thereof.

In an illustrative aspect, a second method of making a cold dessert having an outer surface is provide. The method comprises the step of combining a frozen edible composition with an oil to form the cold dessert, wherein the oil present in an oil container and wherein the oil is added to the frozen edible composition via a pump from the oil container.

In an embodiment, the oil container is a tank comprising the oil. In an embodiment, the oil container is a hopper comprising the oil.

In an embodiment, the combination comprising the frozen edible composition and the oil is extruded via an extrusion nozzle. In an embodiment, the extruded combination is subsequently contacted with a fat-based coating on an outer surface of the extruded combination. In an embodiment, the fat-based coating comprises a chocolate. In an embodiment, the fat-based coating comprises a confection.

In an embodiment, the combining of the frozen edible composition and the oil provides fat agglomeration in a continuous phase of the cold dessert. In an embodiment, the fat agglomeration of the cold dessert is larger than fat agglomeration of a comparative cold dessert, wherein the comparative cold dessert does not comprise an oil.

In an embodiment, the combining of the frozen edible composition and the oil provides a lower number of voids on the outer surface of the cold dessert in comparison to a comparative cold dessert comprising voids, wherein the comparative cold dessert does not comprise an oil.

In an embodiment, the combining of the frozen edible composition and the oil provides a lower number of air pockets on the outer surface of the cold dessert in comparison to a comparative cold dessert comprising air pockets, wherein the comparative cold dessert does not comprise an oil.

In an embodiment, the frozen edible composition comprises a base composition. In an embodiment, the base composition comprises an ingredient selected from the group consisting of milk, ultrafiltered milk, low-lactose milk, whole milk, buttermilk, skim milk, ultrafiltered low-lactose skim milk, cream, water, cocoa powder, sweetener, inulin, soluble corn fiber, sugar alcohol, stabilizer, emulsifier, and any combination thereof.

In an embodiment, the frozen edible composition comprises an ingredient selected from the group consisting of salt, sea salt, natural flavors, inclusions, variegates, and any combination thereof.

In an embodiment, the frozen edible composition comprises an ingredient selected from the group consisting of fruits, nuts, chocolate-based inclusions, chocolate-based variegates, and any combination thereof.

In an embodiment, the frozen edible composition comprises an ingredient selected from the group consisting of vanilla, nut extract, peanut extract, chocolate flavor, chocolate cheesecake flavor, caramel variegate, sea salt caramel variegate, strawberry variegate, blueberry variegate, peanut variegate, peanut butter variegate, peanut butter flake variegate, chocolate variegate, chocolate fudge variegate, fudge variegate, and any combination thereof.

In an embodiment, the oil comprises a low-melt oil. In an embodiment, the low-melt oil is an edible low-melt oil. In an embodiment, the low-melt oil is selected from the group consisting of peanut oil, soybean oil, canola oil, sunflower oil, safflower oil and any combination thereof.

### Example 1

### Exemplary Recipes and Formulations

The cold desserts of the present disclosure comprise a frozen edible composition and an oil. The frozen edible composition comprises a base composition and, optionally, includes other ingredients.

Various recipes and formulas can be utilized to formulate the frozen edible compositions. For example, the base composition can comprise ingredients at various different percentages or ranges of percentages. Certain exemplary base compositions’ ingredients are shown in Tables 1-8.

TABLE 1

| Ingredient | Usage (%) |
|---|---|
| Ultrafiltered low-lactose skim milk | 25.0 -75.0% |
| Water | 20.0 -75.0% |
| Cream | 10.0 - 50.0% |
| Cocoa powder | 0.1 - 10% |
| Sweeteners | 2 - 15% |
| Fiber | 0.1 - 10% |
| Stabilizers and emulsifiers | 0.1 - 2% |
| Salt | 0.1 - 2% |
| Natural flavors | 0.05 - 1 % |
| Inclusions and variegates | 1 - 15% |
| Low-melt oils | 0.1% - 10% |

TABLE 2

| Ingredient | Usage (%) |
|---|---|
| Ultrafiltered low-lactose skim milk | 30.0 - 70.0% |
| Water | 25.0 -75.0% |
| Cream | 15.0 - 40.0% |
| Cocoa powder | 1-7% |
| Sweeteners | 3 - 10% |
| Fiber | 1-7% |
| Stabilizers and emulsifiers | 0.2 -12% |
| Salt | 0.2 - 1% |
| Natural flavors | 0.1 - 0.5% |
| Inclusions and variegates | 3 - 10% |
| Low-melt oils | 0.5% - 7% |

TABLE 3

| Ingredient | Usage (%) |
|---|---|
| Ultrafiltered low-lactose skim milk | 38.0 - 61.0% |
| Water | 30.0 - 70.0% |
| Cream | 16.0 - 39.0% |
| Cocoa powder | 1.2 - 5.8 % |
| Sweeteners | 3.7 - 8.7% |
| Fiber | 2.5 - 5.4% |
| Stabilizers and emulsifiers | 0.12 - 0.87% |
| Salt | 0.21 - 0.49% |
| Natural flavors | 0.06 - 0.42% |
| Inclusions and variegates | 2.6 - 9.8% |
| Low-melt oils | 0.2% - 5.9% |

TABLE 4

| Ingredient | Usage (%) |
|---|---|
| Ultrafiltered low-lactose skim milk | 33.0 - 61.0% |
| Water | 30.0 - 65.0% |
| Cream | 18.0 - 37.0% |
| Cocoa powder | 1.8 - 4.7 % |
| Sweeteners | 4.1 - 8.3% |
| Fiber | 2.8 - 5.9% |
| Stabilizers and emulsifiers | 0.18-0.67% |
| Salt | 0.26 - 0.44% |
| Natural flavors | 0.11-0.36% |
| Inclusions and variegates | 3.3 - 8.9% |
| Low-melt oils | 0.6% - 5.3% |

TABLE 5

| Ingredient | Usage (%) |
|---|---|
| Ultrafiltered low-lactose skim milk | 35.0 - 60.0% |
| Water | 40.0 - 70.0% |
| Cream | 20.0 - 30.0% |
| Cocoa powder | 2-5% |
| Sweeteners | 5-8% |
| Fiber | 3-5% |
| Stabilizers and emulsifiers | 1 -8% |
| Salt | 0.4 - 0.8% |
| Natural flavors | 0.2 - 0.4% |
| Inclusions and variegates | 5-8% |
| Low-melt oils | 2.5% - 5% |

TABLE 6

| Ingredient | Usage (%) |
|---|---|
| Ultrafiltered low-lactose skim milk | 40.0 - 50.0% |
| Water | 60.0 - 70.0% |
| Cream | 20.0 - 25.0% |
| Cocoa powder | 1-3% |
| Sweeteners | 3-6% |
| Fiber | 3-5% |
| Stabilizers and emulsifiers | 3-5% |
| Salt | 0.4 - 0.6% |
| Natural flavors | 0.2 - 0.4% |
| Inclusions and variegates | 5 - 10% |
| Low-melt oils | 2.5% - 8% |

TABLE 7

| Ingredient | Usage (%) |
|---|---|
| Ultrafiltered low-lactose skim milk | 29.0 - 56.0% |
| Water | 50.0 - 70.0% |
| Cream | 21.0 - 33.0% |
| Cocoa powder | 1.9 - 3.7% |
| Sweeteners | 4.8 - 7.3% |
| Fiber | 2.9 - 5.3% |
| Stabilizers and emulsifiers | 0.21 - 0.47% |
| Salt | 0.30 - 0.40% |
| Natural flavors | 0.15 - 0.33% |
| Inclusions and variegates | 3.9 - 8.0% |
| Low-melt oils | 1.0% - 5.3% |

TABLE 8

| Ingredient | Usage (%) |
|---|---|
| Ultrafiltered low-lactose skim milk | 28.0 - 56.0% |
| Water | 50.0 -75.0% |
| Cream | 19.0 - 34.0% |
| Cocoa powder | 1.1-4.0% |
| Sweeteners | 4.6 - 8.0% |
| Fiber | 2.9 - 4.9% |
| Stabilizers and emulsifiers | 0.15 - 0.57% |
| Salt | 0.29 - 0.39% |
| Natural flavors | 0.18 - 0.31% |
| Inclusions and variegates | 3.0 - 7.9% |
| Low-melt oils | 1.0% - 5.0% |

### Example 2

### Evaluation of Cold Desserts That Do Not Comprise Oil

For the instant example, a base composition was prepared via combination of ingredients using a high shear mixer. The base composition was homogenized using a two-stage homogenizer at 1000-5000 psi pressure and then pasteurized. Thereafter, the pasteurized base composition was aged for at least four hours and then sent to flavor tanks to add various flavoring ingredients.

The composition was then passed through a commercial freezer. Subsequently, other ingredients (e.g., variegates and inclusions) were added to the composition to result in a frozen edible composition. Similar to known cold desserts currently on the market, the frozen edible composition did not include an oil.

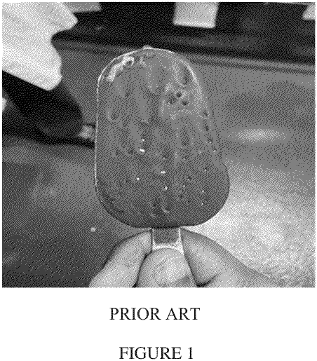

A fat-based coating comprising chocolate was then applied to the cold dessert of the instant example. As shown in FIG. 1, the cold dessert that did not comprise an oil demonstrates an inferior surface quality when a fat-based coating is added to its exterior. For instance, the undesirable qualities shown in FIG. 1 include numerous surface imperfections such as bumps, air pockets, and holes.

### Example 3

### Evaluation of Cold Desserts Comprising Oil

For the instant example, a base composition was prepared via combination of ingredients using a high shear mixer. The base composition was homogenized using a two-stage homogenizer at 1000-5000 psi pressure and then pasteurized. Thereafter, the pasteurized base composition was aged for at least four hours and then sent to flavor tanks to add various flavoring ingredients.

The composition was then passed through a commercial freezer. Subsequently, other ingredients (e.g., variegates and inclusions) were added to the composition to result in a final frozen edible composition. Thereafter, upon removing the frozen edible composition from the 0° C. freezer, a low-melt oil was combined with the frozen edible composition to form the cold dessert.

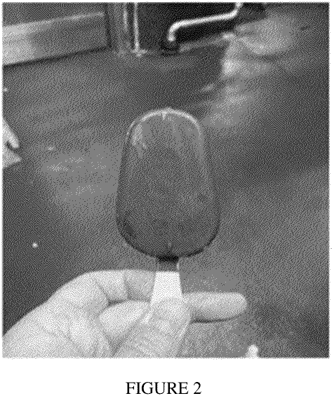

A fat-based coating comprising chocolate was then applied to the cold dessert of the instant example. As shown in FIG. 2, the cold dessert comprising an oil demonstrates an improved surface quality when a fat-based coating is added to its exterior. For instance, FIG. 2 shows a smooth cold dessert that desirably does not include surface imperfections.

### Example 4

### Microscopic Evaluation of Cold Desserts With and Without Oil

Similar to the cold desserts prepared in Examples 2 and 3, two different cold desserts were prepared for the instant example. The first sample (“Sample A”) was a cold dessert comprising a frozen edible composition but did not comprise oil, similar to the cold dessert prepared in Example 2. The second sample (“Sample B”) was cold dessert comprising a frozen edible composition and oil, similar to the cold dessert prepared in Example 3. Both samples were then evaluated under a microscope at various magnifications to evaluate differences in fat agglomeration in the continuous phase of the samples.

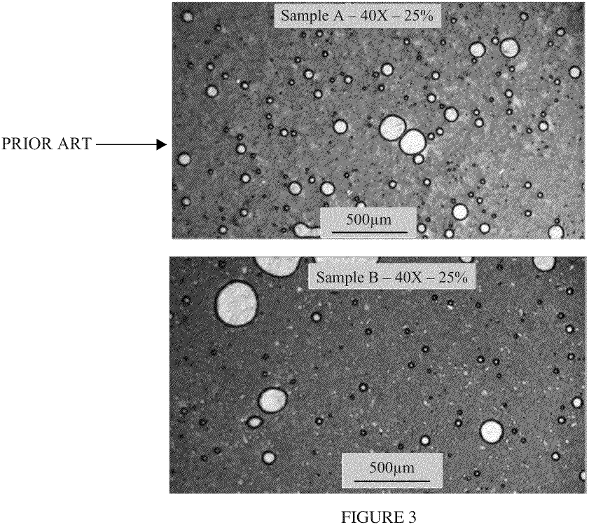

FIG. 3 shows microscopic images at 40X (with Sample A at the top and Sample B at the bottom). Neither sample melted readily on the slide, which is a sign of substantial fat agglomeration. However, under low magnification, much larger particles fat agglomeration were clearly observed in Sample B.

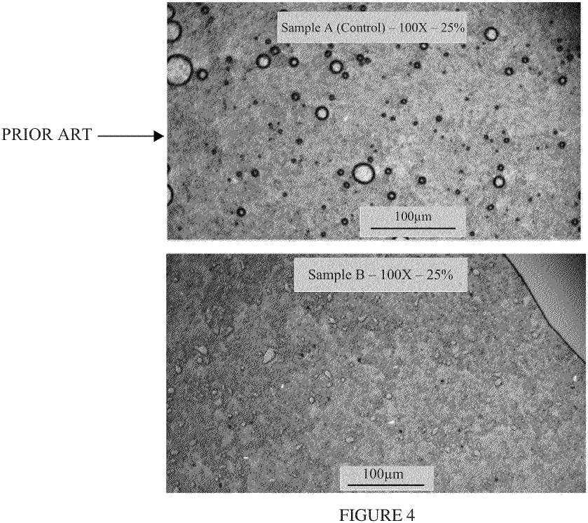

FIG. 4 shows microscopic images at 100X (with Sample A at the top and Sample B at the bottom). The larger particles fat agglomeration in Sample B were shown as beginning to resemble the appearance of fat regions, which is indicative of excessive agglomeration during freezing.

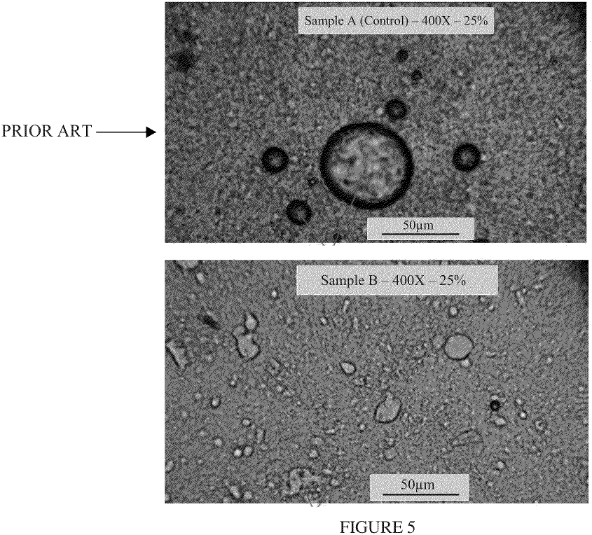

FIG. 5 shows microscopic images at 400X (with Sample A at the top and Sample B at the bottom). The images clearly demonstrate larger fat agglomerates in the continuous phase of Sample B in comparison to Sample A.

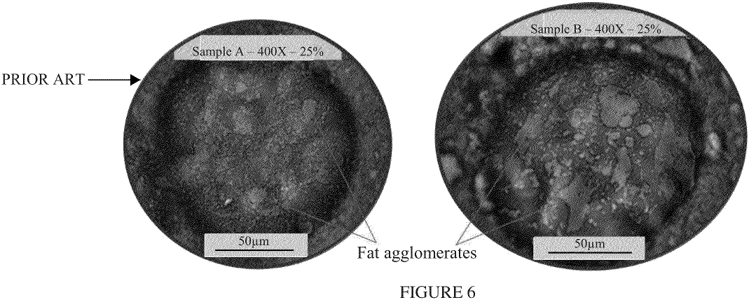

FIG. 6 shows microscopic images at 400X (with Sample A on the left and Sample B on the right) and focuses on air cells present in the samples. At the air cell surface, Sample A demonstrates a fat agglomeration network as developed from a finer emulsion, which leads to more uniform air cell coating. In comparison, Sample B shows significant fat agglomeration from a more coarse emulsion. Sample B demonstrates much larger masses of agglomerated fat as well as a less uniform coating on the air cell.

1. A cold dessert comprising
i) a frozen edible composition; wherein the frozen edible composition comprises an ingredient selected from the group consisting of fruits, nuts, chocolate-based inclusions, chocolate-based variegates, and any combination thereof; and
ii) a low-melt oil selected from the group consisting of peanut oil, soybean oil, canola oil, sunflower oil, safflower oil, and any combination thereof combined with the frozen edible composition, wherein the cold dessert has an outer surface.

2. The cold dessert of claim 1, wherein the frozen edible composition comprises a base composition comprising an ingredient selected from the group consisting of milk, ultrafiltered milk, low-lactose milk, whole milk, buttermilk, skim milk, ultrafiltered low-lactose skim milk, cream, water, cocoa powder, sweetener, inulin, soluble corn fiber, sugar alcohol, stabilizer, emulsifier, and any combination thereof.

3. The cold dessert of claim 1, wherein the frozen edible composition comprises an ingredient selected from the group consisting of salt, sea salt, natural flavors, inclusions, variegates, and any combination thereof.

4. (canceled)

5. The cold dessert of claim 1, wherein the cold dessert comprises a fat-based coating configured to interface with the outer surface of the cold dessert.

6. The cold dessert of claim 5, wherein the fat-based coating comprises a chocolate.

7. (canceled)

8. (canceled)

9. The cold dessert of claim 1, wherein the cold dessert comprises a continuous phase, and wherein the continuous phase comprises a fat agglomeration.

10. The cold dessert of claim 9, wherein the fat agglomeration of the cold dessert is larger than a fat agglomeration of a comparative cold dessert, wherein the comparative cold dessert does not comprise a low-melt oil.

11. The cold dessert of claim 1, wherein the cold dessert comprises a lower number of voids on the outer surface of the cold dessert in comparison to a comparative cold dessert comprising voids, wherein the comparative cold dessert does not comprise a low-melt oil.

12. The cold dessert of claim 1, wherein the cold dessert comprises a lower number of air pockets on the outer surface of the cold dessert in comparison to a comparative cold dessert comprising air pockets, wherein the comparative cold dessert does not comprise a low-melt oil.

13. A method of making a cold dessert having an outer surface, said method comprising the step of combining a frozen edible composition, wherein the frozen edible composition comprises an ingredient selected from the group consisting of fruits, nuts, chocolate-based inclusions, chocolate-based variegates, and any combination thereof with a low-melt oil selected from the group consisting of peanut oil, soybean oil, canola oil, sunflower oil, safflower oil and any combination thereof to form the cold dessert.

14. The method of claim 13, wherein the combining of the frozen edible composition and the low-melt oil provides fat agglomeration in a continuous phase of the cold dessert.

15. The method of claim 14, wherein the fat agglomeration of the cold dessert is larger than a fat agglomeration of a comparative cold dessert, wherein the comparative cold dessert does not comprise a low-melt oil.

16. The method of claim 13, wherein the combining of the frozen edible composition and the low-melt oil provides a lower number of voids on the outer surface of the cold dessert in comparison to a comparative cold dessert comprising voids, wherein the comparative cold dessert does not comprise a low-melt oil.

17. The method of claim 13, wherein the combining of the frozen edible composition and the low-melt oil provides a lower number of air pockets on the outer surface of the cold dessert in comparison to a comparative cold dessert comprising air pockets, wherein the comparative cold dessert does not comprise a low-melt oil.

18. The method of claim 13, wherein the method further comprises a step of contacting the cold dessert with a fat-based coating, wherein the fat-based coating is applied to the outer surface of the cold dessert.

19. (canceled)

20. (canceled)
